(19) United States
(12) Patent Application Publication
(10) Pub. No.: US 2009/0235491 A1
(43) Pub. Date: Sep. 24, 2009

(54) Casket swing handle

(76) Inventor: Gary L. Cox, Richmond, IN (US)

Correspondence Address: Harold C. Moore;Maginot, Moore & Beck, Chase Tower, Suite 3250, 111 Monument Circle, Indianapolis, IN, 46204-5109, US

(21) Appl. No.: 12/383,121

(22) Filed: Mar. 19, 2009

Related U.S. Application Data
(60) Provisional application No. 61/070,020, filed on Mar. 19, 2008.

(51) Int. Cl. B25G 1/00; A61G 17/04; B25G 3/38

(52) U.S. Cl. 16/439

(57) ABSTRACT

A handle arrangement for a container for a deceased, the handle arrangement including a side wall of the container, and a handle assembly, and a slidable linkage arrangement. The side wall includes at least a first opening. The handle arrangement, the handle assembly includes a gripping surface and a connector, the connector including a first connector end disposed proximate a top of the container, and a second connector end disposed proximate a bottom of a container. The connector is rotatably connected to the side wall, the rotatable connection defining a pivot point that is closer to the first connector end than to the second connector end. The slidable linkage arrangement has a first end, a second end, and an intermediate portion therebetween. The first end is operably coupled to the connector at a position closer to the second connector end than to the first connector end. The intermediate body extends through the first opening. The second end disposed such that the first end and the second end are disposed on opposite sides of the side wall.

This application claims the benefit of U.S. Provisional Patent Application Ser. No. 61/070,020, filed Mar. 19, 2008, and which is incorporated here by reference.

### FIELD OF THE INVENTION

The present invention relates generally to burial and cremation containers.

### BACKGROUND

Cremation containers are containers in which a deceased may be placed prior to cremation. Cremation containers range from elaborate hardwood caskets to simple corrugated paper cartons. Some cremation containers are intended to be consumed during cremation, and others are not. Burial containers are containers in which a deceased is placed for interment. Caskets and/or containers can in many cases be used for either purpose.

Cremation is often considered to be a low cost funerary option, as it eliminates the need for interment space. Extremely low funerary costs can be achieved by employing a corrugated paper cremation container, which is a fraction of the cost of hardwood or metal caskets. Even if cost is not a major consideration, corrugated paper caskets are a popular choice for cremation. Paper caskets are preferred, in part, because they are completely consumed during the cremation process so there are no metal components remaining in the ash after the cremation.

Many corrugated paper caskets have design elements that approximate decorative wood or steel caskets. Many people find such paper caskets to be suitable for presentation at a viewing and/or memorial service. These ornately designed paper caskets represent a cost savings over hardwood caskets, and are particularly advantageous in cases in which the casket is to be consumed during the cremation process.

While ornately designed paper caskets are less expensive than hardwood caskets, they still represent a significant cost that may not be practical in some cases. In such cases, the least expensive option is a simple rectangular corrugated paper container and associated simple rectangular lid that fits over the container in a manner similar to that of a common shoe box. The deceased fits within the container and then the rectangular lid is fitted over the container to close off the casket.

One drawback associated with the simple rectangular paper container is the perceived lack of dignity that the container provides. While the simple rectangular paper container may not be intended for elaborate funerary proceedings, there is still a need for identification of a deceased by the next-of-kin, and often a need for the closest relatives to pay last respects. Such viewings are often emotional in nature, and it desirable to provide the appearance of some dignity, even if expensive containers are not an option.

There is a need therefore, for a casket or cremation container that retains much or all of the economy of the simple rectangular container design while providing additional aesthetic display of the deceased for identification and viewing purposes.

Another problem with prior art corrugated box container caskets relates to handles for carrying the container. Typically, a handle is formed as a cut-out in the corrugated container. However, a drawback associated with this type of handle is that one lifting the casket could contact the remains located within the casket. Therefore, there is also a need for a handle that may be used with corrugated container and other relatively inexpensive caskets that allows the casket to be easily and comfortably lifted while shielding the casket bearer from the remains of the deceased.

In wood and metal caskets, a long bar handle is typically provided on the outside of the container. However, many of such structures are not readily compatible with a corrugated container, because of the strength requirement for the connection between that handle and the casket wall.

Moreover, an external handle can add to the width the container. An overly wide unit presents a number of problems including increased difficulty moving the container through doorways or other passages, and incurs additional shipment and storage costs. Accordingly, maintaining a narrow profile is beneficial.

### SUMMARY

At least some embodiments of the present invention address some of the above-referenced issues by providing a rotatable handle arrangement on a casket/container wall. In general, the handle rotates upward from a non-used position to a carrying position. In these embodiments, the handle includes a connector that is configured to, in the carrying position, distribute load to strengthen the integrity of the handle and container.

A first embodiment of the invention is a handle arrangement for a container for a deceased, the handle arrangement including a side wall of the container, and a handle assembly, and a slidable linkage arrangement. The side wall includes at least a first opening. The handle arrangement, the handle assembly includes a gripping surface and a connector, the connector including a first connector end disposed proximate a top of the container, and a second connector end disposed proximate a bottom of a container. The connector is rotatably connected to the side wall, the rotatable connection defining a pivot point that is closer to the first connector end than to the second connector end. The slidable linkage arrangement has a first end, a second end, and an intermediate portion therebetween. The first end is operably coupled to the connector at a position closer to the second connector end than to the first connector end. The intermediate body extends through the first opening. The second end disposed such that the first end and the second end are disposed on opposite sides of the side wall.

The slidable linkage assembly provides a mechanism that helps distributed the load born by the handle differently than if the entire load was borne at or proximate to the pivot point of the rotatable connector.

The above described features and advantages, as well as others, will become more readily apparent to those of ordinary skill in the art by reference to the following detailed description and accompanying drawings.

### BRIEF DESCRIPTION OF THE DRAWINGS

FIG. 1 shows a perspective view of a casket system incorporating casket swing arm system mounted on a casket in accordance with a first embodiment of the invention.

FIG. 2 shows a plan view of an exemplary handle assembly that may be used in the swing arm system of FIG. 1;

FIG. 3 shows a cutaway view of the handle assembly of FIG. 2.

FIG. 4 shows a plan view of a second exemplary handle assembly that may be used in embodiments of the invention.

FIG. 5 shows a perspective view of an exemplary embodiment of a slidable linkage element that may be used in the swing arm system of FIG. 1;

FIG. 6 shows a top plan view of the slidable linkage element of FIG. 5;

FIG. 7 shows a side plan view of the slidable linkage element of FIG. 5;

FIG. 8 shows a fragmentary plan view of the handle assembly of FIG. 2 coupled to an end of the slidable linkage element of FIG. 5;

FIG. 9 shows a fragmentary cutaway view of the handle assembly of FIG. 2 coupled to an end of the slidable linkage element of FIG. 5;

FIG. 10 shows a perspective view of a retainer for the slidable linkage element of FIG. 5;

FIG. 11 shows a plan view of an end the retainer of FIG. 10;

FIG. 12 shows a fragmentary perspective view of an end of the slidable linkage element of FIG. 5 disposed within the retainer of FIG. 10;

FIG. 13 shows a fragmentary perspective view of the swing arm system of FIG. 1 showing the internal and external elements of the system in a first position;

FIG. 14 shows a fragmentary perspective view of the swing arm system of FIG. 1 showing the internal and external elements of the system in a second position;

FIG. 15 shows a fragmentary perspective view of the swing arm system of FIG. 1 showing the internal and external elements of the system in the first position, with all elements of the casket other than the casket wall removed;

FIG. 16 shows a fragmentary perspective view of the swing arm system of FIG. 1 showing the internal and external elements of the system in the second position, with all elements of the casket other than the casket wall removed;

FIG. 17 shows a perspective view of another embodiment of a swing arm system according to the present invention apart from the casket or container;

FIG. 18 shows a perspective view of another the swing arm system of FIG. 17 assembled into a fragmentary portion of a side wall of a casket or container.

### DESCRIPTION

For the purposes of promoting an understanding of the principles of the invention, reference will now be made to the embodiments illustrated in the drawings and described in the following written description. It is understood that no limitation to the scope of the invention is thereby intended. It is further understood that the present invention includes any alterations and modifications to the illustrated embodiments and includes further applications of the principles of the invention as would normally occur to one skilled in the art to which this invention pertains.

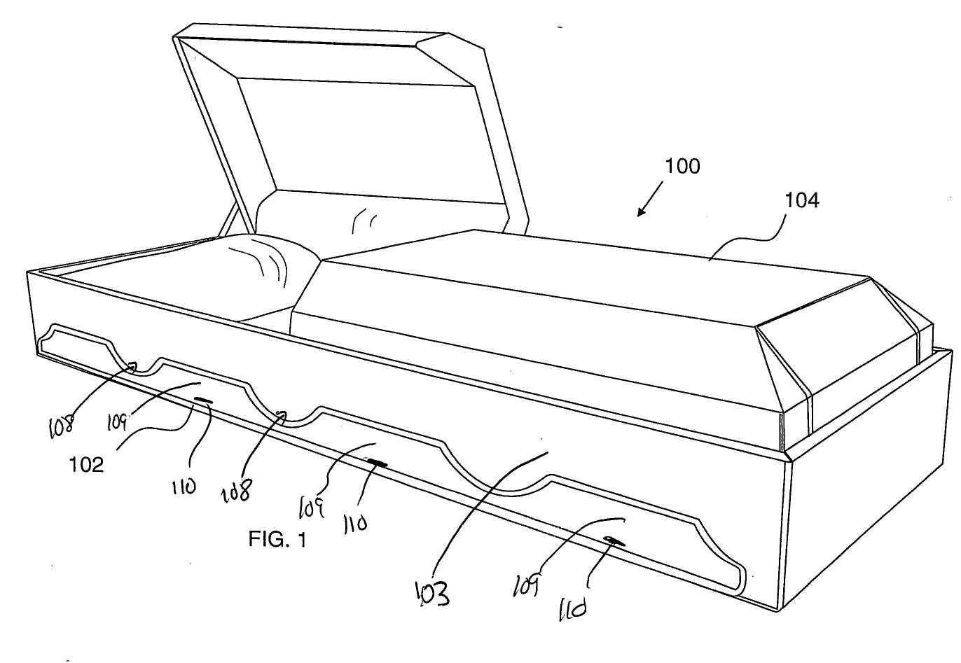

FIG. 1 shows a perspective view of a casket system 100 incorporating casket swing arm system 102 mounted on a casket 104. The casket may be constructed of cardboard, wood or any other acceptable material. In this embodiment, the casket 104 is constructed of 32 ECT single wall and double wall kraft paper.

The swing arm system 102 may be more or less ornate than shown. The swing arm system 102 may be fabricated of wood or plastic for use in cremation containers. In other embodiments, metals and other materials may be used. Additionally, while swing arm system 102 is show herein in use with a casket system 100, they may alternatively be used in any temporary container system wherein easy of carrying is desired without unduly adding to the width of the container. Such temporary container systems include containers used for packaging of appliances, e.g., dishwashers, ovens and the like.

As will be discussed below in detail, the swing arm system 102 coordinates with the side wall 103 of the casket system 100 to form a handle arrangement that provides at least some advantages of the invention, including, for example, distribution of weight force away from the pivot point that is defined at or near the top of the swing arm assembly 102.

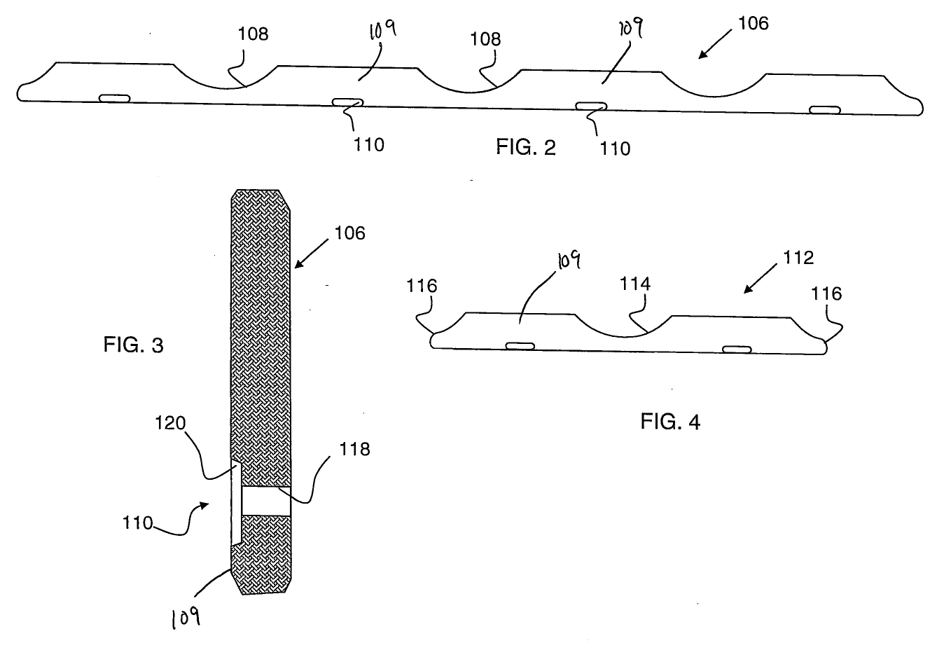

The swing arm system 102 includes a handle assembly or swing arm 106 shown in FIG. 2. The swing arm 106 includes a number of grip areas 108, connector structures 109, and connector ports 110. While the embodiment of FIG. 2 includes three grip areas 108, more or fewer grip areas may be provided in alternative embodiments. By way of example, the swing arm 112 of FIG. 4 includes a single grip area 114. If desired, the end portions 116 may be used in addition to or in place of the grip area 114.

The connector structures 109 form the structures that rotatably connect to the side wall 103 of the casket system 100. It is further noted that in this embodiment, the connector structures 109 are integrally formed with the grip areas 108, i.e. as a single piece of wood. However, in alternative embodiments, the gripping portion may be a long rigid bar that fits through holes of multiple separate connector structures.

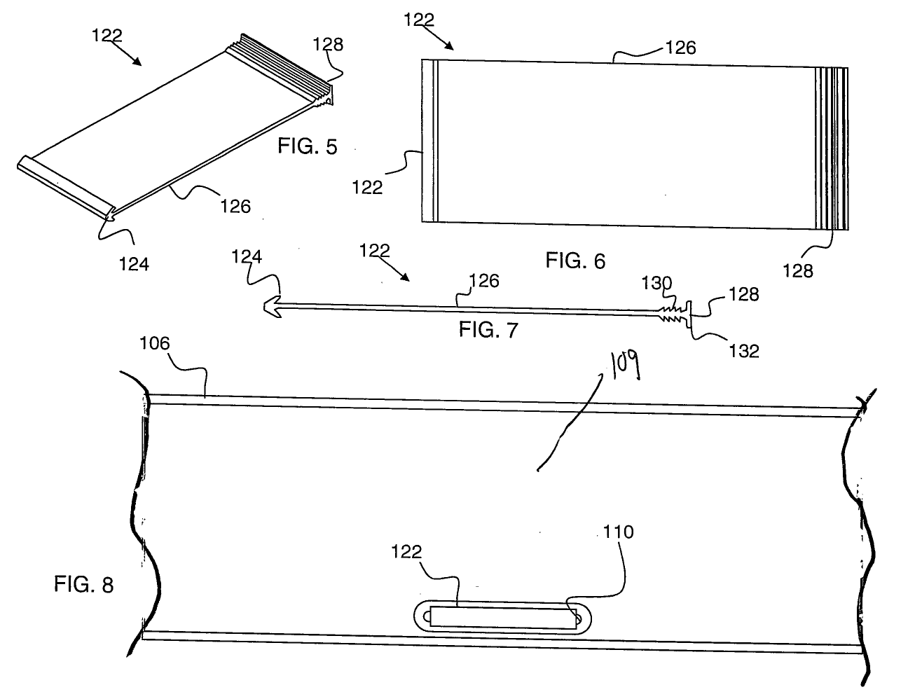

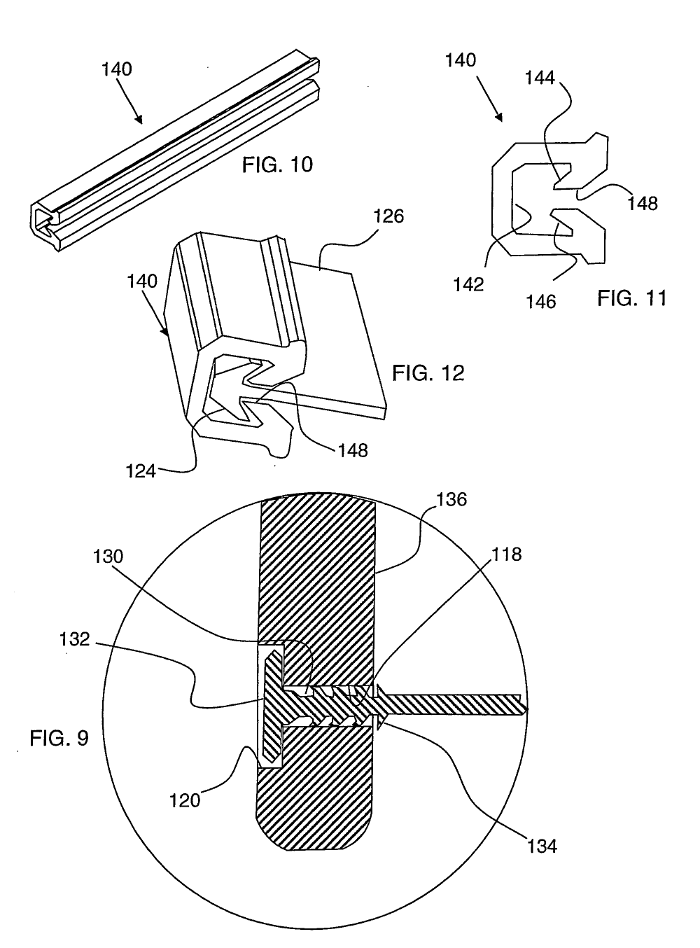

Referring to FIG. 3, the port 110 extends completely through the swing arm 106 and includes a lower bore 118 and a countersunk portion 120. The port 110 is configured to receive a slidable linkage element 122 shown in FIGS. 5-7. The slidable linkage element 122 includes an anchor portion 124, a shaft portion 126 and a head portion 128. The head portion 128 includes a barbed section 130 and a flange portion 132. The barbed section 130 and the flange portion 132 are configured such that when the slidable linkage element 122 is positioned in the swing arm 106 as depicted in FIG. 8, the slidable linkage element 122 is maintained within the port 110 as explained in reference to FIG. 9.

In FIG. 9, most of the barbed section 130 is located within the lower bore 118 and the flange portion 132 is positioned within the countersunk portion 120. The barbed section 130 is configured such that at least a lower barb 134 is not positioned within the lower bore 118. Rather, the lower barb 134 is positioned against an inwardly facing wall 136 of the swing arm 106. Thus, the flange portion 132 and the lower barb 134 clamp the swing arm 106 while the remaining barbs located in the lower bore 118 frictionally engage the wall of the lower bore 118.

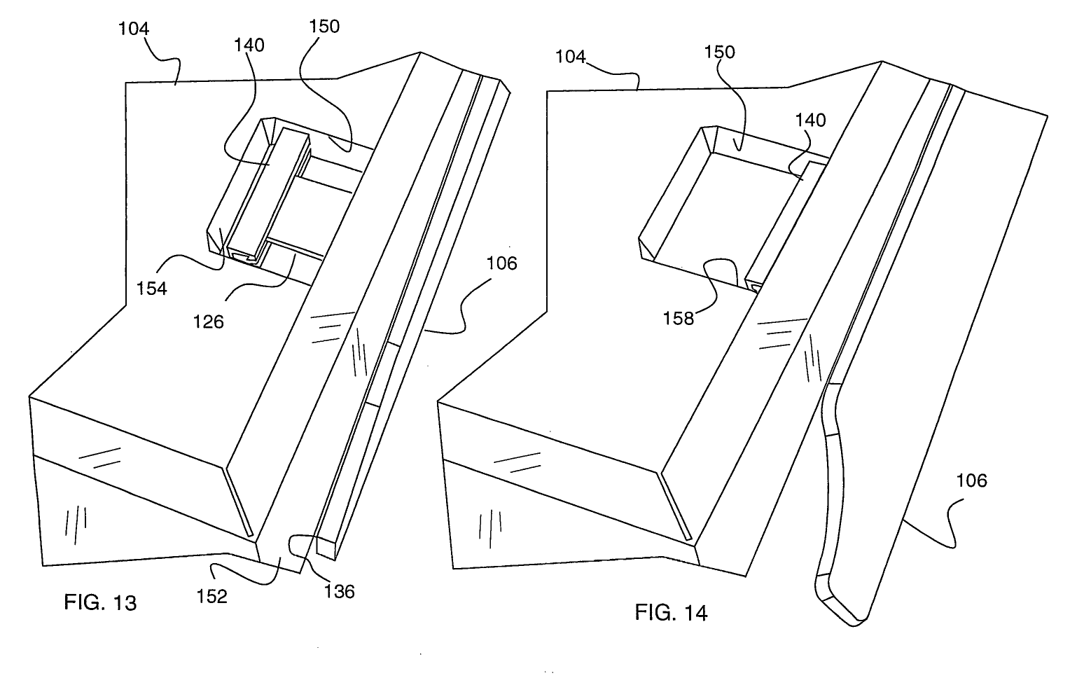

The anchor portion 124 is configured to be inserted within a stop member 140 shown in FIGS. 10 and 11. The stop member 140 includes a channel 142 and two inwardly extending retaining lips 144 and 146. The retaining lips 144 and 146 define a slot portion 148. The channel 142 and the two inwardly extending retaining lips 144 and 146 are formed complementary to the anchor 124. Thus, as shown in FIG. 12, the inwardly extending retaining lips 144 and 146 maintain the anchor portion 124 within the channel 142 and the shaft 126 of the slidable linkage element 122 extends outwardly through the slot portion 148.

The stop member 140 is configured to be positioned within a trench 150 of the casket 104 as shown in FIG. 13. In FIG. 13, the swing arm 106 is positioned with the inwardly facing wall 136 laying against the side wall 152 of the casket 104. In the position, a large portion of the shaft 126 is within the trench 150 and the stop member 140 is located at the rear portion 154 of the trench 150.

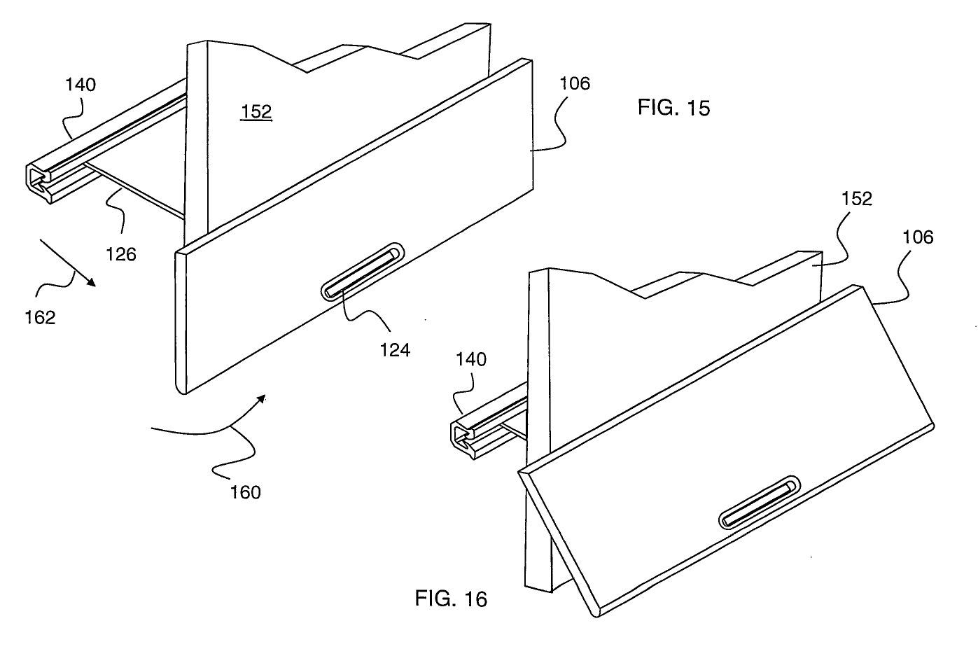

FIG. 14 shows the location of components of the swing arm system 102 after rotation of the swing arm 106 in the direction of the arrow 156 of FIG. 13. As shown in FIG. 14, the rotation of the swing arm has caused the stop member 140 to be located at a forward portion 158 of the trench 150. The movement is discussed with reference to FIGS. 15 and 16. As the swing arm 106 is rotated in the direction of the arrow 160 of FIG. 15, the swing arm presses against the flange portion 132 of the slidable linkage element member 122. The force from the swing arm 106 is transferred through the shaft portion 126 to the anchoring portion 124.

As shown in FIG. 12, the anchoring portion 124 is maintained within the stop member 140 by the inwardly extending retaining lips 144 and 146. Accordingly, the stop member 140 is pulled in the direction of the arrow 162 of FIG. 13 to the position shown in FIG. 16 wherein the swing arm 106 has been rotated about 40 degrees off of vertical. The rotation of the swing arm 106 is limited by the length of the trench 150 and the shaft portion 126 of the slidable linkage element member 122. Once the stop member 140 abuts the forward wall of the trench 150, further rotation of the swing arm 106 is restricted.

The forty degree angle is selected to provide for ample clearance between the swing arm 106 and the side wall 152 of the casket 104 to provide for a good hand hold. Limiting the rotation of the swing arm 106 ensures that a significant amount of the force applied to the swing arm 104 by a user, such as when the casket 104 is lifted, is transferred at a relatively steep angle to the casket. This allows the swing arm 106 to be mounted to the side wall 152 using a light weight hinge. In this embodiment, the side wall 152 is cut to form a flap. The swing arm 106 is then mounted on the flap (not shown) which functions as a hinge. It will appreciated that those of ordinary skill in the art may readily devise any number of suitable hingers.

Nevertheless, the use of a flap allows the swing arm 106 to be rotated to an angle less than 90 degrees, and most preferably within the range of 30-60 degrees. Larger angles may be provided by use of heavy duty hinges or in applications with relatively low forces.

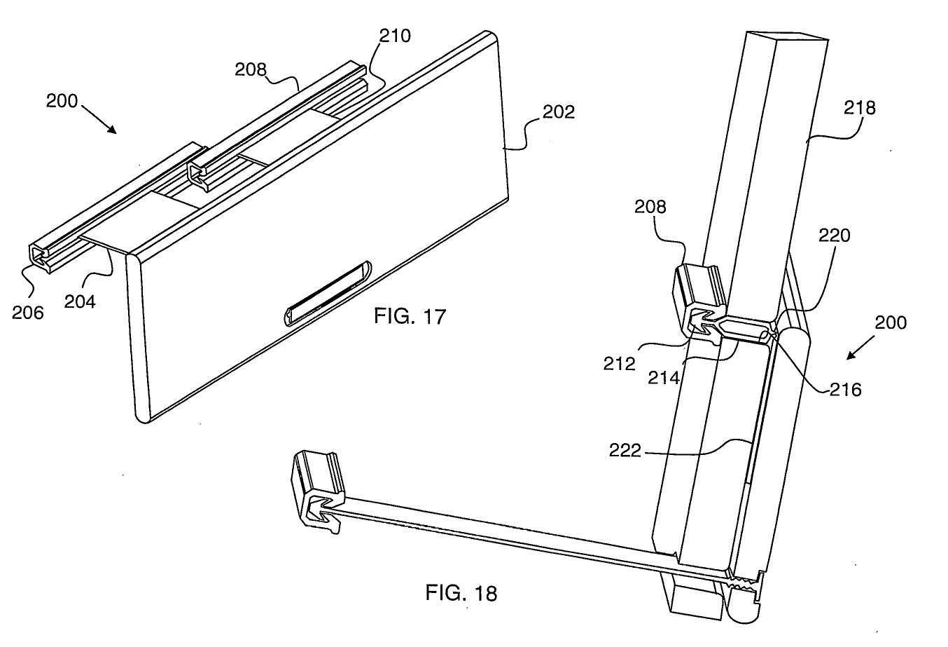

In further embodiments, the side wall of the casket is not used to provide the hinge. One such embodiment is shown in FIGS. 17 and 18. The swing arm system 200 includes a swing arm 202, a slidable linkage element 204, and a stop member 206, each of which functions in like manner to the respective components of the swing arm system 102. The swing arm system 200 further includes an anchor member 208 and a hinge 210 which are shown more clearly in FIG. 18.

The anchor member 208 is configured like the stop member 140. The hinge 210 includes an anchoring portion 212 which is retained within the anchor member 208. A shank portion 214 extends through a slot 216 in a side wall 218. A loop portion 220 is located between the shank portion 214 and a landing portion 222. The swing arm 202 is attached to the landing portion 222 using, for example, adhesives. Alternatively, the hinge 210 may be integrally formed with the swing arm 202. The loop portion 202 allows for rotation of the swing arm 202 away from the side wall 218.

Various elements of the swing arm system may be manufactured from alternative materials. By way of example, they may be molded from a polypropylene. The components may be manufactured in a number of methods including injection molding. Moreover, many detailed features have been disclosed herein that provide additional advantages beyond those of the present invention, or indeed enhance the present invention. It will be appreciated that many of the advantages of the present invention may be obtained without such detailed features. The principles of the present invention have widespread applications, and may be incorporated into any number of designs by those of ordinary skill in the art.

We claim:

1. A handle arrangement for a container for a deceased, the handle arrangement comprising:
a side wall of a container for the deceased, the side wall including at least a first opening;
a handle assembly, the handle assembly including a gripping surface and a connector, the connector including a first connector end disposed proximate a top of the container, and a second connector end disposed proximate a bottom of a container, the connector rotatably connected to the side wall, the rotatable connection defining a pivot point that is closer to the first connector end as opposed to the second connector end;
a slidable linkage arrangement having a first end, a second end, and an intermediate portion therebetween, the first end operably coupled to the connector at a position closer to the second connector end than the first connector end, and the intermediate body extending through the first opening, and the second end disposed such that the first end and the second end are disposed on opposite sides of the side wall.

2. The handle arrangement of claim 1, wherein the second end of the slidable linkage arrangement includes a stop piece, the stop piece dimensioned to prohibit movement of the second end through the first opening.

3. The handle arrangement of claim 1, wherein the side wall includes a second opening disposed above the first opening, and further comprising a second linkage arrangement, the second linkage arrange having a first end coupled to the first connector end, a second end, and an intermediate portion extending through the second opening.

4. The handle arrangement of claim 1, further comprising a hinge coupled between the first connector end and the side wall.

5. The handle arrangement of claim 1, wherein the gripping surface and the connector are integrally formed.

6. The handle arrangement of claim 1, wherein the gripping surface comprises a bar that extends through an opening in the connector.
